(19) United States
(12) Patent Application Publication
(10) Pub. No.: US 2018/0029329 A1
(43) Pub. Date: Feb. 1, 2018

(54) RELEASE AGENT COMPOSITION, RELEASE SHEET, SINGLE-SIDED PRESSURE-SENSITIVE ADHESIVE SHEET AND DOUBLE-SIDED (FACED) PRESSURE-SENSITIVE ADHESIVE SHEET

(71) Applicant: Lintec Corporation, Tokyo (JP)

(72) Inventors: Chiharu HIRANO, Tokyo (JP); Sou MIYATA, Tokyo (JP)

(21) Appl. No.: 15/553,142

(22) PCT Filed: Feb. 23, 2016
(86) PCT No.: PCT/JP2016/055300

§ 371 Date: Aug. 23, 2017

(30) Foreign Application Priority Data
Feb. 24, 2015 (JP) 2015-034445

(51) Int. Cl. B32B 7/06; C08L 67/00; B32B 7/12; C09J 7/02; B32B 27/30; B32B 27/36

(52) U.S. Cl. CPC B32B 7/06; B32B 27/30; B32B 27/36; B32B 7/12; C09J 7/0228; C08L 67/00; B32B 2309/105; C09J 2467/005; C09J 2433/005

(57) ABSTRACT

A release agent composition may include a polyester resin (A) and an acrylic polymer (B) in which the acrylic polymer (B) may include a structural unit represented by any structural formula disclosed herein, and a ratio of a blending amount of the polyester resin (A) to a blending amount of the acrylic polymer (B) may be in the range of (A):(B)=50:50 to 95:5 in a mass ratio. The release agent composition may be used to form a release sheet for a single-sided pressure-sensitive adhesive sheet or release sheets for a double-sided (faced) pressure-sensitive adhesive sheet. Further, when the release sheet is wound up in a rolled form, it is possible to suppress the release agent composition from transferring to a surface of the base material of the release sheet and to impart an easy peeling property to the release sheet.

### TECHNICAL FIELD

The present invention relates to a release agent composition, a release sheet, a single-sided pressure-sensitive adhesive sheet and a double-sided (faced) pressure-sensitive adhesive sheet.

### RELATED ART

Electric components such as relays, various switches, connectors, motors, and hard disk drives are widely used in various products.

In these electronic components, a pressure-sensitive adhesive sheet is used for various purposes such as temporal fastening of parts during assembly and indication of contents of the parts.

Such a pressure-sensitive adhesive sheet generally includes a pressure-sensitive adhesive sheet body which is composed of a pressure-sensitive adhesive sheet base and a pressure-sensitive adhesive layer. The pressure-sensitive adhesive sheet further includes a release sheet which is composed of a base material and a release agent layer before the pressure-sensitive adhesive sheet body is attached to an electric component. Namely, the pressure-sensitive adhesive sheet has a structure in which the pressure-sensitive adhesive layer of the pressure-sensitive adhesive sheet body adheres to the release agent layer of the release sheet before the pressure-sensitive adhesive sheet body is attached to the electric component.

This release agent layer is provided on a surface of the base material of the release sheet (surface to be in contact with the pressure-sensitive adhesive layer) for a purpose of improving releasability. Conventionally, a silicone resin has been used as a constituent material of this release agent layer (see, e.g., Patent Document 1).

By the way, it is known that when such a release sheet is attached to the pressure-sensitive adhesive sheet body, a silicone compound such as low-molecular weight silicone resin, siloxane, silicone oil, or the like contained in the release sheet is transferred to the pressure-sensitive adhesive layer of the pressure-sensitive adhesive sheet body.

In a case where the pressure-sensitive adhesive sheet body, to which such a release sheet has adhered, is attached to the electric component, the silicone compound transferred to the pressure-sensitive adhesive layer or a surface of the pressure-sensitive adhesive sheet body (surface of the pressure-sensitive adhesive sheet body opposite to the pressure-sensitive adhesive layer) gradually vaporizes. It is known that the vaporized silicone compound is deposited on, for example, a surface of an electric contact portion of the electric component due to electric arc or the like generated near the electric contact portion to form a minute silicone compound layer or a silicon oxide-based compound layer derived from the silicone compound. If such a silicone compound or such a silicon oxide-based compound derived from the silicone compound is deposited on the surface of the electric contact portion, there is a case where electric conductivity becomes poor. Particularly, in a case where such a pressure-sensitive adhesive sheet body is attached to a hard disk drive, the silicone compound transferred to the pressure-sensitive adhesive layer or the surface of the pressure-sensitive adhesive sheet body gradually vaporizes, and thus the silicone compound or the silicon oxide-based compound derived from the silicone compound is deposited on a magnetic head, a disk surface, or the like. As a result, there is a possibility that deposition of the minute silicone compound or the silicon oxide-based compound gives rise to adverse effects on reading and writing of data from and to the disk of the hard disk drive.

In order to solve the above problems, attempts to develop a non-silicone-based release agent containing no silicone compound have been made (see, e.g., Patent Document 2). However, a release sheet composed of a release agent layer containing such a conventional non-silicone-based release agent tends to have a tight peeling property.

For the purpose of improving to have such a tight peeling property, a release sheet with a long-chain alkyl based release agent has been developed (see, e.g., Patent Document 3).

However, when the release sheet described in Patent Document 3 is wound up in a rolled form after the production thereof, a back surface of the release sheet (surface of the base material of the release sheet) is in contact with the release agent layer thereof. As a result, there is a problem in that the release agent contained in the release agent layer is transferred to the surface of the base material of the release sheet. Further, when the surface of the base material of the release sheet is in contact with the surface of the pressure-sensitive adhesive sheet body, the release agent transferred to the surface of the base material of the release sheet is further transferred to the surface of the pressure-sensitive adhesive sheet body. For this reason, typing and printing qualities on the surface of the pressure-sensitive adhesive sheet body are lowered. As a result, in a case where the pressure-sensitive adhesive sheet body is used for the purpose of the indication of the contents, some problems occur. Furthermore, when manufacturing the pressure-sensitive adhesive sheet with roll-to-roll, the release agent is transferred to and accumulated in a guide roll, which may cause problems such as poor conveyance of the pressure-sensitive adhesive sheet and secondary transfer of the release agent to other products.

Further, it is difficult for the release agent composition described in Patent Document 3 to realize a sufficient easy peeling property. Further, in order to improve releasability, when the carbon number of an alkyl group of a side chain is increased, the alkyl group of the side chain is crystallized, which in turn results in having the tight peeling property. In addition, since solubility of the release agent composition in an organic solvent is lowered, when the release agent composition (solution) is applied to the base material to form a coating film, a problem may occur in which processability of the coating film containing the release agent composition is lowered.

The Patent Document 1 is JP-A 1994-336574

The Patent Document 2 is JP-A 2004-162048

The Patent Document 3 is WO 2012-20673

### SUMMARY OF THE INVENTION

It is therefore an object of the present invention to provide a release agent composition which is hard to transfer to a surface of a base material of a release sheet when the release sheet formed from the release agent composition is wound up in the rolled form and is capable of imparting an easy peeling property to the release sheet, and to provide a release sheet formed from such a release agent composition, a single-sided pressure-sensitive adhesive sheet having such a release sheet and a double-sided (faced) pressure-sensitive adhesive sheet having such release sheets.

The above object is achieved by the inventions (1) to (17) set forth below.

(1) A release agent composition, comprising:

a polyester resin (A) and an acrylic polymer (B),

wherein the acrylic polymer (B) includes a structural unit represented by the following structural formula (1) and

wherein a ratio of a blending amount of the polyester resin (A) to a blending amount of the acrylic polymer (B) is in the range of (A):(B)=50:50 to 95:5 in a mass ratio.

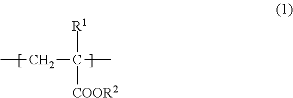

In the formula (1) R¹ is H or CH₃ and R² is an alkyl group having a branched structure and having carbon atoms of 10 or more and 30 or less.

(2) The release agent composition in the above-mentioned invention (1) further comprising a crosslinking agent (C).

(3) In the release agent composition described in the above-mentioned invention (1) or (2), the acrylic polymer (B) includes 80 mass % or more of the structural unit represented by the structural formula (1).

(4) In the release agent composition described in any one of the above-mentioned inventions (1) to (3), the acrylic polymer (B) has at least one functional group selected from the group consisting of a hydroxyl group, an amino group and a carboxyl group.

(5) In the release agent composition described in any one of the above-mentioned inventions (1) to (4), the polyester resin (A) has a number average molecular weight of 500 or more and 10,000 or less.

(6) In the release agent composition described in any one of the above-mentioned inventions (1) to (5), the acrylic polymer (B) has a mass average molecular weight of 50,000 or more and 500,000 or less.

(7) In the release agent composition described in any one of the above-mentioned inventions (1) to (6), an amount of a silicone compound contained in the release agent composition is measured by X-ray photoelectron spectroscopy (XPS), and the amount is 0.5 atomic % or less.

(8) A release sheet comprising:

a base material; and

a release agent layer composed of a cured product of the release agent composition described in any one of the above-mentioned inventions (1) to (7) and provided on at least a side of one surface of the base material.

(9) In the release sheet described in the above-mentioned invention (8), a surface free energy of the release agent layer is measured by a contact angle method, and the surface free energy is 40 mJ/m² or less.

(10) In the release sheet described in the above-mentioned invention (8) or (9), a ratio of C element on a surface of the release agent layer in a surface element analysis is measured by XPS, and the ratio of C element is 85 atomic % or more.

(11) In the release sheet described in any one of the above-mentioned inventions (8) to (10), a ratio of Si element on a surface of the release agent layer in a surface element analysis is measured by XPS, and the ratio of Si element is less than 0.5 atomic %.

(12) In the release sheet described in any one of the above-mentioned inventions (8) to (11), after a polyester film is contacted with the release agent layer of the release sheet and is left for 24 hours under a pressure of 10 kg/cm² at room temperature, a release agent component occupied ratio in the polyester film is 40% or less, in which the release agent component occupied ratio is obtained by conducting a surface element analysis by XPS for a surface of the polyester film contacting with the release agent layer.

(13) In the release sheet described in any one of the above-mentioned inventions (8) to (12), the release agent layer has an average thickness of 0.01 μm or more and 1.0 μm or less.

(14) A single-sided pressure-sensitive adhesive sheet comprising:

a pressure-sensitive adhesive sheet base;

a pressure-sensitive adhesive layer laminated on a surface of the pressure-sensitive adhesive sheet base; and

a release sheet laminated on an adhesive surface of the pressure-sensitive adhesive layer,

wherein the release sheet is formed from the release sheet described in any one of the above-mentioned inventions (8) to (13).

(15) In the single-sided pressure-sensitive adhesive sheet described in the above-mentioned invention (14), the pressure-sensitive adhesive layer is used for indication of a content of an adherend to which the pressure-sensitive adhesive layer adheres.

(16) A double-sided pressure-sensitive adhesive sheet comprising:

a core material;

two pressure-sensitive adhesive layers laminated on both surfaces of the core material respectively,

two release sheets laminated on adhesive surfaces of the two pressure-sensitive adhesive layers respectively,

wherein at least one of the two release sheets is formed from the release sheet described in any one of the above-mentioned inventions (8) to (13).

(17) A double-faced pressure-sensitive adhesive sheet comprising:

a pressure-sensitive adhesive layer;

two release sheets laminated on both surfaces of the pressure-sensitive adhesive layer respectively,

wherein at least one of the two release sheets is formed from the release sheet described in any one of the above-mentioned inventions (8) to (13).

According to the present invention, it is possible to provide the release agent composition which is hard to transfer to the surface of the base material of the release sheet when the release sheet formed from the release agent composition is wound up in the rolled form and to provide the release sheet formed from such a release agent composition.

Further, according to the present invention, it is possible to provide the release agent composition which is capable of suppressing crystallization of a side chain of an acrylic polymer (B) and imparting an easy peeling property to the release sheet, and to provide the release sheet formed from such a release agent composition.

Furthermore, according to the present invention, it is possible to provide the single-sided pressure-sensitive adhesive sheet which has excellent typing and printing qualities on a surface thereof.

Moreover, according to the present invention, it is possible to provide the release agent composition which can sufficiently suppress the adverse effects on adherends (for example, electric components such as relays, various switches, connectors, motors, and hard disk drives), and to provide the release sheet formed from such a release agent composition, the single-sided pressure-sensitive adhesive sheet having such a release sheet and the double-sided (faced) pressure-sensitive adhesive sheet having such release sheets.

### BRIEF DESCRIPTION OF THE DRAWINGS

FIG. 1 is a cross sectional view of a preferred embodiment of a release sheet according to the present invention.

FIG. 2 is a cross sectional view of a preferred embodiment of a single-sided pressure-sensitive adhesive sheet according to the present invention.

FIG. 3 is a cross sectional view of a first embodiment of a double-sided pressure-sensitive adhesive sheet according to the present invention.

FIG. 4 is a cross sectional view of a second embodiment of a double-faced pressure-sensitive adhesive sheet according to the present invention.

### DETAILED DESCRIPTION OF THE PREFERRED EMBODIMENTS

Hereinbelow, a release agent composition, a release sheet, a single-sided pressure-sensitive adhesive sheet and a double-sided (faced) pressure-sensitive adhesive sheet according to the present invention will be described in detail based on preferred embodiments thereof. In this regard, the single-sided pressure-sensitive adhesive sheet and the double-sided (faced) pressure-sensitive adhesive sheet may be simply referred to as “pressure-sensitive adhesive sheet” or “pressure-sensitive adhesive article”.

<Release Sheet>

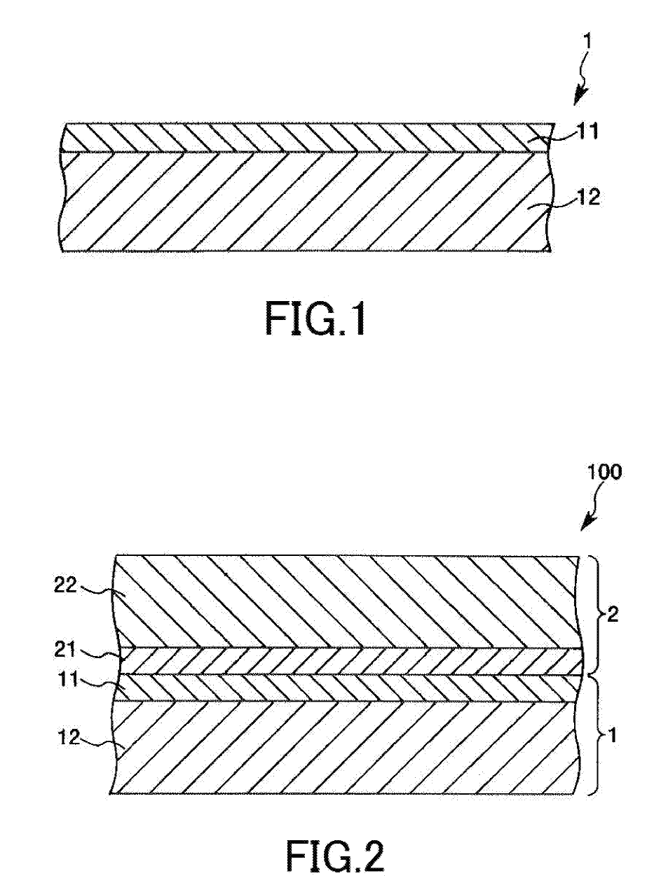

FIG. 1 is a cross sectional view of a preferred embodiment of a release sheet according to the present invention. It is to be noted that in the following description, the upper side in FIG. 1 will be referred to as “upper” or “upper side” and the lower side in FIG. 1 will be referred to as “lower” or “lower side”. Hereinbelow, the release agent composition and the release sheet will be described in detail.

As shown in FIG. 1, a release sheet 1 has a structure in which a release agent layer 11 is formed on a base material 12.

The base material 12 has a function of supporting the release agent layer 11.

The base material 12 is constituted from, for example, a plastic film such as polyester film (e.g., polyethylene terephthalate film, polybutylene terephthalate film, or the like), polyolefin film (e.g., polypropylene film, polymethylpentene film, or the like), polycarbonate film, or the like; a metal foil such as aluminum foil, stainless steel foil, or the like; paper such as glassine paper, high quality paper, coated paper, impregnated paper, synthetic paper, or the like; or laminated paper obtained by coating such a paper base material with a thermoplastic resin such as polyethylene, or the like.

An average thickness of the base material 12 is not particularly limited, but is preferably 5 μm or more, and more preferably 10 μm or more. Further, the average thickness of the base material 12 is not particularly limited, but is preferably 300 μm or less, and more preferably 200 μm or less.

By providing the release agent layer 11 on the base material 12, it is possible to peel off a pressure-sensitive adhesive sheet body from the release sheet 1 when a pressure-sensitive adhesive sheet described later is prepared.

The release agent layer 11 is formed by curing the release agent composition according to the present invention.

The release agent composition according to the present invention has a feature which includes a polyester resin (A) and an acrylic polymer (B), in which the acrylic polymer (B) has a structural unit represented by the following structural formula (1) and a ratio of a blending amount of the polyester resin (A) to a blending amount of the acrylic polymer (B) is in the range of (A):(B)=50:50 to 95:5 in a mass ratio.

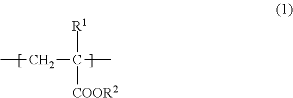

In the formula (1) R¹ is H or CH₃ and R² is an alkyl group having a branched structure and having carbon atoms of 10 or more and 30 or less.

By such features of the release agent composition, it is possible to suppress the release agent composition (release agent) from transferring to a surface of the base material 12 of the release sheet 1 (surface of the base material 12 opposite to the release agent layer 11). For this reason, when a single-sided pressure-sensitive adhesive sheet described later is wound up, it is possible to suppress the release agent composition from transferring to a surface of the pressure-sensitive adhesive sheet body described later (surface of the pressure-sensitive adhesive sheet body opposite to the pressure-sensitive adhesive layer) via the surface of the base material 12 of the release sheet 1. As a result, typing and printing qualities on the surface of the pressure-sensitive adhesive sheet body are improved. Further, when manufacturing the pressure-sensitive adhesive sheet with roll-to-roll, it is possible to suppress the release agent from transferring to and accumulating in a guide roll, and thus to suppress occurrence of problems such as poor conveyance of the pressure-sensitive adhesive sheet and secondary transfer of the release agent to other products.

In addition, it is possible to reduce a release force when peeling off the pressure-sensitive adhesive sheet body from the release sheet 1. Specifically, the release agent composition contains the polyester resin (A) and the acrylic polymer (B) at a predetermined ratio, thereby it becomes possible to make the acrylic polymer (B) adequately and unevenly distributed on the surface of the release agent layer 11 (surface of the release agent layer 11 opposite to the base material 12). As a result, the density of carbon chains on the surface of the release agent layer 11 increases, and thereby it becomes possible to impart the easy peeling property to the release sheet 1.

Furthermore, the release agent composition according to the present invention includes the acrylic polymer (B) which has an alkyl group with a branched structure as a side chain. This makes it possible to suppress crystallization of the side chain even when the carbon number of the alkyl group of the side chain increases in order to improve the releasability. As a result, it is possible to suppress the surface of the release agent layer 11 from having the tight peeling property due to the crystallization of the side chain.

Moreover, the acrylic polymer (B) has the alkyl group having the branched structure and having carbon atoms of 10 or more and 30 or less as the side chain, thereby it is possible to suppress the release agent composition including such an acrylic polymer (B) from transferring to the base material 12 and the pressure-sensitive adhesive layer.

Each component of the release agent composition will be described in detail below.

[Polyester Resin (A)]

The polyester resin (A) is not particularly limited, and can be appropriately selected from known polyester resins. Specific examples of the polyester resin include a resin obtained by condensation reaction of a polyvalent alcohol and a polybasic acid. For example, such a polyester resin includes a condensate of a dibasic acid and a divalent alcohol; a nonconvertible polyester resin modified with a nondrying oil fatty acid or the like; a convertible polyester resin which is a condensate of a dibasic acid and a trivalent or higher alcohol; and so on. Any of these polyester resins can be used in the present invention.

Examples of the polyvalent alcohol used as a raw material of the polyester resin include a divalent alcohol such as ethylene glycol, diethylene glycol, triethylene glycol, propylene glycol, trimethylene glycol, tetramethylene glycol, neopentyl glycol, or the like; a trivalent alcohol such as glycerin, trimethylolethane, trimethylolpropane, or the like; and a polyvalent alcohol having a valence of 4 or higher such as diglycerin, triglycerin, pentaerythritol, dipentaerythritol, mannitol, sorbitol, or the like. One of these polyvalent alcohols may be used alone, or two or more thereof may be used in combination.

Further, examples of the polybasic acid include an aromatic polybasic acid such as phthalic anhydride, terephthalic acid, isophthalic acid, trimellitic anhydride, or the like; an aliphatic saturated polybasic acid such as succinic acid, adipic acid, sebacic acid, or the like; an aliphatic unsaturated polybasic acid such as maleic acid, maleic anhydride, fumaric acid, itaconic acid, citraconic anhydride, or the like; a polybasic acid based on the Diels-Alder reaction such as cyclopentadiene-maleic anhydride adduct, terpene-maleic anhydride adduct, rosin-maleic anhydride adduct, or the like. One of these polybasic acids may be used alone, or two or more thereof may be used in combination.

Further, examples of the nondrying oil fatty acid or the like, which is a modifying agent, include an octylic acid, a lauric acid, a palmitic acid, a stearic acid, an oleic acid, a linoleic acid, a linolenic acid, an eleostearic acid, a ricinoleic acid and a dehydrated ricinoleic acid, as well as a coconut oil, a linseed oil, a tung oil, a castor oil, a dehydrated castor oil, a soybean oil and a safflower oil; and fatty acids thereof and the like. One of these nondrying oil fatty acids and the like may be used alone, or two or more thereof may be used in combination. Moreover, one of the resultant polyester resins may be used alone or two or more thereof may be used in combination.

The polyester resin (A) preferably has a reactive functional group for reaction with a crosslinking agent, and more preferably the reactive functional group is a hydroxyl group. Further, the hydroxyl value of the polyester resin (A) is preferably 5 mgKOH/g or more and more preferably 10 mgKOH/g or more. Furthermore, the hydroxyl value of the polyester resin (A) is preferably 500 mgKOH/g or less and more preferably 300 mgKOH/g or less.

Moreover, a number average molecular weight of the polyester resin (A) is preferably 500 or more and more preferably 1,000 or more. In addition, the number average molecular weight of the polyester resin (A) is preferably 10,000 or less and more preferably 5,000 or less. The polyester resin (A) has a relatively low number average molecular weight as stated here, thereby a network structure formed in the release agent composition when cross-linked tends to be dense, and the acrylic-based polymer (B) tends to be unevenly distributed on the surface of the release agent layer 11.

The content of the polyester resin (A) in the release agent composition is preferably 20 mass % or more and more preferably 40 mass % or more. Further, the content of the polyester resin (A) in the release agent composition is preferably 99 mass % or less and more preferably 95 mass % or less.

[Acrylic Polymer (B)]

The acrylic polymer (B) has the above structural formula (1) as the structural unit. By including such an acrylic polymer (B) in the release agent composition, it is possible to suppress the release agent composition from transferring to a rear surface of the release sheet 1 (surface of the base material 12 opposite to the release agent layer 11). As a result, it is possible to suppress the release agent composition from transferring to the surface of the pressure-sensitive adhesive sheet body via the rear surface of the release sheet 1, and thus the typing and printing qualities on the surface of the pressure-sensitive adhesive sheet body are improved. In addition, it becomes possible to impart the easy peeling property to the release sheet 1.

In the above structural formula (1), R² is the alkyl group having the branched structure and having carbon atoms of 10 or more, but the alkyl group preferably has the branched structure and carbon atoms of 16 or more and more preferably has the branched structure and carbon atoms of 22 or more. This makes it possible to suppress the release agent composition from transferring to the surface of the base material 12 of the release sheet 1 and the pressure-sensitive adhesive layer. On the other hand, when the number of carbon atoms of the alkyl group constituting R² in the above structural formula (1) is less than the above-mentioned lower limit value, a glass transition temperature of the acrylic polymer (B) may remarkably decrease and the releasability of the release agent layer 11 may decrease.

In the above structural formula (1), R² is the alkyl group having the branched structure and having carbon atoms of 30 or less, but the alkyl group preferably has the branched structure and carbon atoms of 28 or less and more preferably has the branched structure and carbon atoms of 26 or less. This makes it possible to more effectively suppress the crystallization of the alkyl group. On the other hand, when the number of carbon atoms of the alkyl group constituting R² is more than the above-mentioned upper limit value, crystallinity of the acrylic polymer (B) becomes high, which may cause a problem in that the release sheet 1 is likely to have a tight peeling property. In addition, since solubility of the release agent composition in an organic solvent is lowered, when the release agent composition (solution) is applied to the base material 12 to form a coating film, a problem may occur in which processability of the coating film containing the release agent composition is lowered.

It is preferred that the numbers of carbon atoms of the alkyl group constituting R2 in each structural unit of the structural formula (1) included in the acrylic polymer (B) are the same as each other.

In a case where the numbers of carbon atoms of the alkyl group constituting R2 in each structural unit of the structural formula (1) included in the acrylic polymer (B) are different from each other, an average value of the numbers of carbon atoms should be within the range of the above-mentioned number of carbon atoms.

Further, it is preferred that the acrylic polymer (B) has at least one functional group selected from the group consisting of a hydroxyl group, an amino group and a carboxyl group, thereby it becomes possible to react with the crosslinking agent. As a result, it is possible to improve durability of the release agent layer 11 formed therefrom.

Furthermore, a mass average molecular weight of the acrylic polymer (B) is preferably 50,000 or more and more preferably 70,000 or more. Further, the mass average molecular weight of the acrylic polymer (B) is preferably 500,000 or less and more preferably 200,000 or less. Thereby, the acrylic-based polymer (B) tends to be unevenly distributed on the surface of the release agent layer 11, and it becomes possible to further improve the releasability (peeling performance) of the release agent layer 11.

Moreover, the structural unit represented by the above structural formula (1) is preferably included in an amount of 80 mass % or more and more preferably 84 mass % or more in the acrylic polymer (B). In addition, the structural unit represented by the above structural formula (1) is preferably included in an amount of 99.9 mass % or less and more preferably 99.5 mass % or less in the acrylic polymer (B). This makes it possible to impart the easy peeling property to the release sheet 1 and to more easily control the release force of the release sheet 1.

According to the present invention, the ratio of the blending amount of the polyester resin (A) to the blending amount of the acrylic polymer (B) is in the range of (A):(B)=50:50 to 95:5 in the mass ratio, but more preferably in the range of 60:40 to 90:10. If the ratio of the polyester resin (A) is excessively increased, the amount of the acrylic polymer (B) unevenly distributed on the surface of the release agent layer 11 decreases and the peeling performance of the release agent layer 11 may not be sufficiently improved in some cases. On the other hand, when the ratio of the acrylic polymer (B) is excessively increased, blocking may occur easily in some cases.

The content of the acrylic polymer (B) in the release agent composition is preferably 3 mass % or more and more preferably 10 mass % or more. The content of the acrylic polymer (B) in the release agent composition is preferably 70 mass % or less and more preferably 50 mass % or less.

[Crosslinking Agent]

The release agent composition may include a crosslinking agent (C) in addition to the above components.

By including the crosslinking agent (C), the above polyester resin (A) and the acrylic polymer (B) can be crosslinked (cured), and the release agent layer 11 having excellent durability can be formed.

The crosslinking agent (C) is preferably at least one kind selected from the group consisting of a multifunctional amino compound, a multifunctional isocyanate compound, a multifunctional epoxy compound and a multifunctional metal compound. Thereby, the release agent composition can be cured in a short time more effectively and without extremely high temperature heating.

Examples of the multifunctional amino compound include a melamine resin such as methylated melamine resin, butylated melamine resin, or the like; a urea resin such as methylated urea resin, butylated urea resin, or the like; a benzoguanamine resin such as methylated benzoguanamine resin, butylated benzoguanamine resin, or the like; a diamine such as ethylenediamine, tetramethylenediamine, hexamethylenediamine, N,N′-diphenylethylenediamine, p-xylylenediamine, or the like.

Examples of the multifunctional isocyanate compound include diphenylmethane diisocyanate (MDI), tolylene diisocyanate (TDI), hexamethylene diisocyanate (HDI), isophorone diisocyanate (IPDI), trimethylhexamethylene diisocyanate (TMDI), xylene diisocyanate (XDI), naphthalene diisocyanate (NDI), TDI-trimethylolpropane adduct, HDI-trimethylolpropane adduct, IPDI-trimethylolpropane adduct, XDI-trimethylolpropane adduct and the like.

Examples of the multifunctional epoxy compound include N,N,N′,N′-tetraglycidyl-m-xylenediamine, 1,3-bis(N,N-diglycidylaminomethyl)cyclohexane and the like.

Examples of the multifunctional metal compound include an aluminum chelate compound such as aluminum tris(acetylacetonate) and aluminum ethylacetoacetate diisopropylate; a titanium chelate compound such as titanium tetraacetylacetonate, titanium acetylacetonate, titanium octyleneglycolate, tetraisopropoxytitanium and tetramethoxytitanium; trimethoxyaluminum; and the like.

Among them, the multifunctional amino compound is preferable, and the melamine resin, particularly an alkylated melamine resin having an alkyl group having 3 or less carbon atoms is more preferable, and the methylated melamine resin is particularly preferable from the viewpoint of curability.

The content of the cross-linking agent (C) is preferably 1 mass parts or more and 30 mass parts or less relative to 100 mass parts which is the total content of the polyester resin (A) and acrylic polymer (B). Thereby, the release agent composition can be cured more efficiently.

Moreover, a well-known acidic catalyst such as hydrochloric acid, p-toluenesulfonic acid, or the like; and a tin-based catalyst such as dibutyltin laurate or the like may optionally be added to the release agent composition.

Further, it is preferred that an amount of a silicone compound contained in the release agent composition measured by X-ray photoelectron spectroscopy (XPS) is 0.5 atomic % or less. Thereby, it is more reliably suppressed that the silicone compound is transferred from the release sheet 1 to the pressure-sensitive adhesive layer. As a result, after the pressure-sensitive adhesive layer is attached to an adherend, it is more reliably suppressed that the silicone compound and the like are transferred from the pressure-sensitive adhesive layer to the adherend. Therefore, even if the adherend is electronic equipment such as relay, or the like, the pressure-sensitive adhesive layer is particularly hard to give the adverse effect to such an adherend.

The amount of the silicone compound of the release agent composition measured by X-ray photoelectron spectroscopy (XPS) is more preferably 0.1 atomic % or less. The measurement conditions of X-ray photoelectron spectroscopy (XPS) are as follows, and the amount of the silicone compound can be calculated in the following manner using measured values.

Measurement instrument: Quantera SXM manufactured by ULVAC-PHI, INC.

X-ray: AlKα (1486.6 eV)

Takeoff angel: 45°

Elements measured: silicon (Si), oxygen (O) and carbon (C)

The amount of the silicone compound is expressed in “atomic %” calculated by multiplying the value of Si/(Si+C) by 100.

An average thickness of the release agent layer 11 is not particularly limited, but is preferably in the range of 0.01 μm or more, more preferably in the range of 0.03 μm or more and even more preferably in the range of 0.05 μm or more. Further, the average thickness of the release agent layer 11 is preferably in the range of 1.0 μm or less, more preferably in the range of 0.8 μm or less and even more preferably in the range of 0.5 μm or less. If the average thickness of the release agent layer 11 is less than the lower limit value noted above, there is a case where enough peeling performance cannot be obtained when peeling off the pressure-sensitive adhesive sheet body described later from the release sheet 1. On the other hand, if the average thickness of the release agent layer 11 exceeds the upper limit value noted above, there is a case where blocking is likely to occur between the release agent layer 11 and the surface of the base material 12 of the release sheet 1 when the release sheet 1 is wound up in the rolled form so that the peeling performance of the release agent layer 11 is deteriorated due to the blocking.

Examples of a method for curing the release agent composition described above include, but are not limited thereto, methods of irradiation with active energy rays such as ultraviolet ray, electron ray and the like, heating and the like.

A primer layer may be provided between the release agent layer 11 and the base material 12 for the purpose of improving adhesion between the release agent layer 11 and the base material 12.

A surface free energy of the release agent layer 11 formed by curing the release agent composition as described above and measured by a contact angle method is preferably 40 mJ/m² or less, more preferably 37 mJ/m² or less and even more preferably 34 mJ/m² or less. Thereby, it becomes possible to suppress wettability of a pressure-sensitive adhesive contained in the pressure-sensitive adhesive layer described later and attached to the release agent layer 11. As a result, it is possible to prevent the release sheet from having a tight peeling property.

In this specification, the contact angle meter (DM-701, manufactured by Kyowa Interface Science Co., Ltd.) is used for the contact angle measurement by the contact angle method. Then, the contact angles of the surface of the release agent layer 11 of the release sheet 1 with respect to three liquids of water, diiodomethane and dibromonaphthalene are measured (23° C. 50% RH), and the surface free energy is calculated by a Kitasaki Hata method.

A ratio of C element on the surface of the release agent layer 11 in the surface element analysis measured by XPS is preferably 85 atomic % or more, more preferably 89 atomic % or more and even more preferably 92 atomic % or more. Further, the ratio of C element on the surface of the release agent layer 11 in the surface element analysis measured by XPS is more preferably 99 atomic % or less and even more preferably 98 atomic % or less. This makes it possible to more effectively suppress the release agent composition from transferring to the base material 12.

A ratio of Si element on the surface of the release agent layer 11 in the surface element analysis measured by XPS is preferably less than 0.5 atomic %. This makes it possible to more effectively suppress the release agent composition from transferring to the base material 12.

In this specification, PHI Quantera SXM (manufactured by ULVAC-PHI, Inc.) is used for the measurement of the surface of the release agent layer 11 by XPS. The Measurement is carried out at a photoelectron takeoff angle of 45° using monochromatic AlKα as an X-ray source, and an element ratio of carbon, oxygen and silicon existing on the surface of the release agent layer 11 is calculated.

Further, a polyester film is contacted with the release agent layer 11 and is left for 24 hours under a pressure of 10 kg/cm² at room temperature. Afterwards, the release agent layer 11 is removed from the polyester film and the surface element analysis by XPS is conducted for a surface of the polyester film contacted with the release agent layer 11. Thereby the element ratio is obtained and is used for calculating a release agent component occupied ratio of the surface of the polyester film contacted with the release agent layer 11. The release agent component occupied ratio is preferably 40% or less and more preferably 30% or less. The release agent component occupied ratio serves as a measure of an amount (release agent transfer amount) of the release agent of the release agent layer transferred to the polyester film.

In this regard, when the amount of carbon on the surface of the polyester film contacted with the release agent layer 11 obtained in the surface element analysis by XPS is defined as Cₜₒₜₐₗ [atomic %], the amount of carbon on the surface of the polyester film before contacted with the release agent layer 11 is defined as C_{b} (atomic %), the amount of carbon on the surface of the release agent layer 11 is defined as Cₐ [atomic %] and the ratio of the release agent component on the surface of the polyester film contacted with the release agent layer 11 (release agent component occupied ratio) is defined as A %, Cₜₒₜₐₗ={A×Cₐ+(100−A)×C_{b}}/100 is established. According to the formula, it becomes possible to calculate the release agent component occupied ratio A which is the measure of the release agent transfer amount.

<Embodiment of Single-Sided Pressure-Sensitive Adhesive Sheet>

Hereinafter, a preferred embodiment of a single-sided pressure-sensitive adhesive sheet will be described.

FIG. 2 is a cross sectional view of a preferred embodiment of a single-sided pressure-sensitive adhesive sheet according to the present invention.

As shown in FIG. 2, a single-sided pressure-sensitive adhesive sheet 100 is composed of a single-sided pressure-sensitive adhesive sheet body 2 having a pressure-sensitive adhesive sheet base 22 and a pressure-sensitive adhesive layer 21 laminated on a surface of the pressure-sensitive adhesive sheet base 22, and the above release sheet 1 laminated on an adhesive surface of the pressure-sensitive adhesive layer 21.

The pressure-sensitive adhesive sheet base 22 has a function of supporting the pressure-sensitive adhesive layer 21. The pressure-sensitive adhesive sheet base 22 is constituted from a single body, for example, a plastic film such as polyethylene terephthalate film, polybutylene terephthalate film, polyethylene film, polypropylene film, polymethylpentene film, polycarbonate film, or the like; a metal foil such as aluminum foil, stainless steel foil, or the like; paper such as synthetic paper, lint-free paper, high quality paper, art paper, coated paper, glassine paper, or the like; or a laminate body of two or more of them.

Among them, the pressure-sensitive adhesive sheet base 22 is particularly preferably constituted from the plastic film such as polyester film (e.g., polyethylene terephthalate film or polybutylene terephthalate film) or polypropylene film, or so-called lint-free paper from which less dust particles are generated (see, for example, JP-B-H6-11959). When the pressure-sensitive adhesive sheet base 22 is constituted from the plastic film or the lint-free paper, dust particles and the like are less likely to be generated when the single-sided pressure-sensitive adhesive sheet 100 is manufactured and used so that electronic components such as relays are less likely to be adversely affected. In addition, when the pressure-sensitive adhesive sheet base 22 is constituted from the plastic film or the lint-free paper, the pressure-sensitive adhesive sheet base 22 can be easily formed into a desired shape by cutting or die cutting when the single-sided pressure-sensitive adhesive sheet 100 is manufactured. Further, in a case where the plastic film is used as the base (the pressure-sensitive adhesive sheet base 22), the polyethylene terephthalate film is particularly preferable as the plastic film because the polyethylene terephthalate film has the advantages that generation of the dust particles is low and that generation of gas during heating is low.

Further, it is preferred that the pressure-sensitive adhesive sheet base 22 has the typing and printing qualities on its surface.

Further, a surface treatment is preferably made to the surface of the pressure-sensitive adhesive sheet base 22 for the purpose of, for example, improving adhesion of the printing or the typing.

An average thickness of the pressure-sensitive adhesive sheet base 22 is not particularly limited, but is preferably 5 μm or more and more preferably 10 μm or more. Further, the average thickness of the pressure-sensitive adhesive sheet base 22 is preferably 300 μm or less and more preferably 200 μm or less.

The pressure-sensitive adhesive layer 21 is constituted of a pressure-sensitive adhesive composition mainly containing a pressure-sensitive adhesive.

Examples of the pressure-sensitive adhesive include an acrylic-based pressure-sensitive adhesive, a polyester-based pressure-sensitive adhesive and an urethane-based pressure-sensitive adhesive.

For example, in a case where the acrylic-based pressure-sensitive adhesive is used as the pressure-sensitive adhesive, the acrylic-based pressure-sensitive adhesive can be constituted of a polymer or a copolymer mainly formed with a main monomer component for imparting tackiness, a comonomer component for imparting adhesiveness or cohesive force and a functional group-containing monomer component for improving crosslinking site or adhesiveness.

In the following, a case where the pressure-sensitive adhesive is the acrylic-based pressure-sensitive adhesive will be described as a representative, but the present invention is not limited thereto. Further, “(meth)acrylic acid” means both “acrylic acid” and “methacrylic acid”, and the other similar terms are used in the same manner.

Examples of the main monomer component include: (meth)acrylic acid alkyl ester such as ethyl (meth)acrylate, n-butyl (meth)acrylate, isobutyl (meth)acrylate, pentyl (meth) acrylate, n-hexyl (meth) acrylate, 2-ethylhexyl (meth)acrylate, octyl (meth)acrylate, cyclohexyl (meth)acrylate; and the like.

Examples of the comonomer component include methyl (meth)acrylate, lauryl (meth)acrylate, stearyl (meth)acrylate, tridecyl (meth)acrylate, benzyl (meth) acrylate, 2-methoxyethyl (meth) acrylate, vinyl acetate, styrene, acrylonitrile and the like.

Examples of the functional group-containing monomer component include: a carboxyl group-containing monomer such as (meth)acrylic acid, maleic acid, itaconic acid or the like; a hydroxyl group-containing monomer such as 2-hydroxyethyl (meth)acrylate, 2-hydroxypropyl (meth) acrylate, 4-hydroxybutyl (meth) acrylate, N-methylol (meth)acrylamide or the like; (meth)acrylamide; glycidyl (meth)acrylate; and the like.

The polymer or the copolymer which constitutes the acrylic-based pressure-sensitive adhesive contains these components, thereby tackiness and cohesive force of the pressure-sensitive adhesive composition are improved. Further, such an acrylic-based pressure-sensitive adhesive usually has no unsaturated bond in its molecule, and therefore the pressure-sensitive adhesive composition containing the acrylic-based pressure-sensitive adhesive has improved stability with respect to light or oxygen. Further, by appropriately selecting the molecular weight or the kind of monomer, it is possible to obtain a pressure-sensitive adhesive composition having quality and properties suitable for its purpose of use.

The pressure-sensitive adhesive composition may be either of a crosslinked type pressure-sensitive adhesive composition to which crosslinking treatment is carried out or a non-crosslinked type pressure-sensitive adhesive composition to which crosslinking treatment is not carried out. However, the crosslinked type pressure-sensitive adhesive composition is preferably used. By using the crosslinked type pressure-sensitive adhesive composition, it is possible to form the pressure-sensitive adhesive layer 21 having further excellent cohesive force.

Examples of a crosslinking agent to be used for the crosslinked type pressure-sensitive adhesive composition include an epoxy-based compound, an isocyanate compound, a metal chelate compound, a metal alkoxide, a metal salt, an amine compound, a hydrazine compound, an aldehyde compound, and the like.

If necessary, the pressure-sensitive adhesive composition to be used in the present invention may contain various additives such as plasticizer, tackifier, stabilizer, and the like.

An average thickness of the pressure-sensitive adhesive layer 21 is not particularly limited, but is preferably 5 μm or more and more preferably 10 μm or more. Further, the average thickness of the pressure-sensitive adhesive layer 21 is preferably 200 μm or less and more preferably 100 μm or less.

<First Embodiment of Double-Sided (Faced) Pressure-Sensitive Adhesive Sheet>

Next, a preferred embodiment of a double-sided pressure-sensitive adhesive sheet according to the present invention will be described.

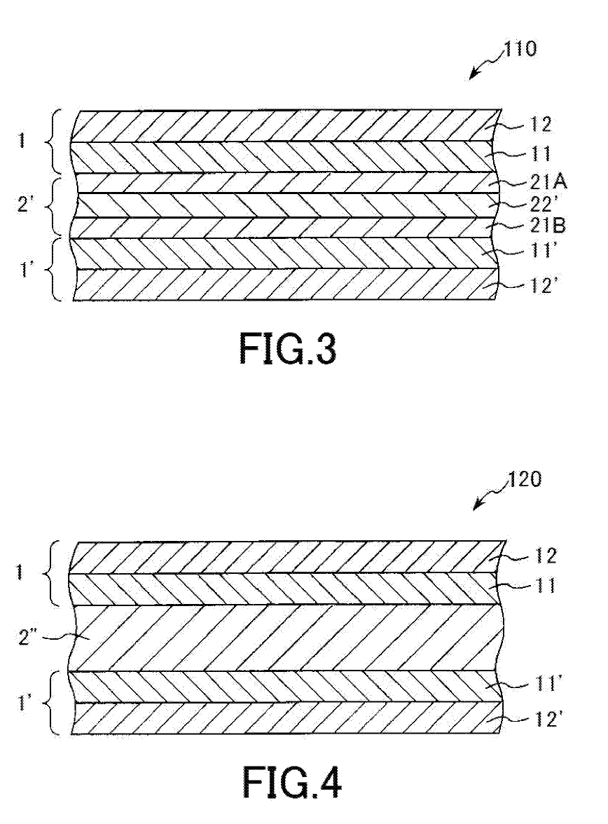

FIG. 3 is a cross sectional view of a first embodiment of a double-sided pressure-sensitive adhesive sheet according to the present invention. It is to be noted that in the following description, the upper side in FIG. 3 will be referred to as “upper” or “upper side” and the lower side in FIG. 3 will be referred to as “lower” or “lower side”.

As shown in FIG. 3, a double-sided pressure-sensitive adhesive sheet 110 according to the present embodiment includes a double-sided pressure-sensitive adhesive sheet body 2′, a release sheet 1 and a release sheet 1′.

The double-sided pressure-sensitive adhesive sheet body 2′ includes a core material 22′, a pressure-sensitive adhesive layer 21A and a pressure-sensitive adhesive layer 21B laminated on both surfaces of the core material 22′ respectively.

The core material 22′ has a function of supporting the pressure-sensitive adhesive layers 21A and 21B, and can be made of the same material as the above-described material of the pressure-sensitive adhesive sheet base 22.

An average thickness of the core material 22′ is not particularly limited, but is preferably 2 μm or more and more preferably 10 μm or more. Further, the average thickness of the core material 22′ is preferably 300 μm or less and more preferably 200 μm or less.

Each of the pressure-sensitive adhesive layers 21A and 21B is constituted of a pressure-sensitive adhesive composition mainly containing the pressure-sensitive adhesive. As the pressure-sensitive adhesive composition which constitutes each of the pressure-sensitive adhesive layers 21A and 21B, the above pressure-sensitive adhesive composition which constitutes the pressure-sensitive adhesive layer 21 of the single-sided pressure-sensitive adhesive sheet 100 can be used.

An average thickness of each of the pressure-sensitive adhesive layers 21A and 21B is not particularly limited, but is preferably 1 μm or more and more preferably 10 μm or more. Further, the average thickness of each of the pressure-sensitive adhesive layers 21A and 21B is preferably 200 μm or less and more preferably 100 μm or less.

As shown in FIG. 3, the release sheet 1 and the release sheet 1′ are laminated on the pressure-sensitive adhesive layer 21A and the pressure-sensitive adhesive layer 21B respectively. That is, the double-sided pressure-sensitive adhesive sheet 110 includes two release sheets 1 and 1′ laminated on adhesive surfaces of the two pressure-sensitive adhesive layers 21A and 21B respectively.

The release sheets 1 and 1′ include release agent layers 11 and 11′ and base materials 12 and 12′ respectively.

As described above, the release agent layer 11 is formed of the cured product of the release agent composition according to the present invention. On the other hand, the release agent layer 11′ of the release sheet 1′ may be formed of the cured product of the release agent composition according to the present invention or may be a cured product of a release agent composition different from the release agent composition according to the present invention.

In the case where the release agent layer 11′ is formed of the cured product of the release agent composition different from the release agent composition according to the present invention, a release force of the release sheet 1 from the pressure-sensitive adhesive layer 21A is preferably larger than that of the release sheet 1′ from the pressure-sensitive adhesive layer 21B. This makes it possible to prevent that the release sheet 1 is unintentionally peeled off from the pressure-sensitive adhesive layer 21A when peeling the release sheet 1′.

Even when the release agent compositions which constitute the release agent layer 11 and the release agent layer 11′ are the same or different, the difference between the release force of the release sheet 1 from the pressure-sensitive adhesive layer 21A and the release force of the release sheet 1′ from the pressure-sensitive adhesive layer 21B is preferably 50 mN/20 mm or more, more preferably 80 mN/20 mm or more and even more preferably 100 mN/20 mm or more. The above difference therebetween is more preferably 700 mN/20 mm or less and particularly preferably 450 mN/20 mm or less. Thereby, when peeling off one release sheet having a smaller release force, it becomes possible to more effectively prevent the other release sheet from unintentionally being peeled off from the pressure-sensitive adhesive layer.

In addition, release forces of the release sheet 1 and the release sheet 1′ from the respective pressure-sensitive adhesive layers 21A and 21B are preferably 1000 mN/20 mm or less, more preferably 800 mN/20 mm or less and even more preferably 600 mN/20 mm or less. Further, the above release forces are more preferably 10 mN/20 mm or more, and particularly preferably 30 mN/20 mm or more. This makes it possible to more easily peeling off the release sheets 1 and 1′ from the pressure-sensitive adhesive sheet body 2′.

In this regard, measurement of the release forces can be performed using a tensile tester. Specifically, the double-sided pressure-sensitive adhesive sheet 110 is seasoned for one week under an atmosphere of 23° C. and 50% RH. Thereafter, the double-sided pressure-sensitive adhesive sheet 110 is cut into a piece having a width of 20 mm and a length of 200 mm to obtain a test piece. One surface of the test piece is fixed on a test stand of the tensile tester with a double-sided tape or the like, and then the release sheet 1 or 1′ being not fixed with the double-sided tape is pulled in the direction of 180° at a speed of 0.3 m/min, thereby the release forces can be measured.

<Second Embodiment of Double-Sided (Faced) Pressure-Sensitive Adhesive Sheet>

Next, a preferred embodiment of a double-faced pressure-sensitive adhesive sheet according to the present invention will be described.

FIG. 4 is a cross sectional view of a second embodiment of a double-faced pressure-sensitive adhesive sheet according to the present invention. It is to be noted that in the following description, the upper side in FIG. 4 will be referred to as “upper” or “upper side” and the lower side in FIG. 4 will be referred to as “lower” or “lower side”.

Hereinafter, the second embodiment of the double-faced pressure-sensitive adhesive sheet will be described with emphasis placed on points differing from the above-described embodiment, and the description of the same matters will be omitted. Further, the same reference numbers are used for the same portions shown in FIG. 4 as those of the first embodiment described above.

The double-faced pressure-sensitive adhesive sheet 120 according to this embodiment is different from the above-described embodiment in that the double-face pressure-sensitive adhesive sheet body 2″ is formed of a single pressure-sensitive adhesive layer.

Even with the double-faced pressure-sensitive adhesive sheet 120 having no core material, it is possible to suppress the release sheet from having a tight peeling property.

<Methods for Producing Release Sheet and Single-Sided Pressure-Sensitive Adhesive Sheet>

Hereinbelow, one example of methods for producing a release sheet 1 and a single-sided pressure-sensitive adhesive sheet 100 will be described.

First, a base material 12 is prepared and a release agent composition as described above is supplied onto the base material 12 to obtain a coating film. Then, by curing the coating film and forming a release agent layer 11, the release sheet 1 is produced.

Examples of a method for curing the release agent composition include, but are not limited thereto, methods of irradiation with active energy rays such as ultraviolet ray, electron ray and the like, heating and the like. This makes it possible to more easily form the release agent layer 11.

Examples of a method for supplying the release agent composition onto the base material 12 include various conventional methods such as gravure coating method, bar coating method, spray coating method, spin coating method, knife coating method, roll coating method, die coating method and the like.

Next, a pressure-sensitive adhesive composition is supplied onto the release agent layer 11 of the release sheet 1 to obtain a coating film. Then, by heating and drying the coating film, a pressure-sensitive adhesive layer 21 is formed.

Examples of a method for supplying the pressure-sensitive adhesive composition onto the release agent layer 11 include various conventional methods such as gravure coating method, bar coating method, spray coating method, spin coating method, knife coating method, roll coating method, die coating method, and the like.

The pressure-sensitive adhesive composition may be of a solvent type, an emulsion type, a hot-melt type, or the like when supplied.

Thereafter, by sticking a pressure-sensitive adhesive sheet base 22 on the formed pressure-sensitive adhesive layer 21, the single-sided pressure-sensitive adhesive sheet 100 can be obtained.

### Method for Producing Double-Sided Pressure-Sensitive Adhesive Sheet (First Embodiment)

Next, one example of a method for producing a double-sided pressure-sensitive adhesive sheet 110 according to the first embodiment will be described.

First, a release sheet 1 and a release sheet 1′ are prepared in the same manner as the method for producing the above release sheet 1 of the single-sided pressure-sensitive adhesive sheet 100.

Next, a pressure-sensitive adhesive composition is supplied onto a release agent layer 11 of the release sheet 1 to obtain a coating film. Then, by heating and drying the coating film, a pressure-sensitive adhesive layer 21A is formed.

In the same manner as above, a pressure-sensitive adhesive composition is supplied onto a release agent layer 11′ of the release sheet 1′ to form a pressure-sensitive adhesive layer 21B.

Next, a core material 22′ is stuck on the formed pressure-sensitive adhesive layer 21A.

Thereafter, by sticking the core material 22′ on the pressure-sensitive adhesive layer 21B formed on the release sheet 1′, the double-sided pressure-sensitive adhesive sheet 110 can be obtained.

### Method for Producing Double-Faced Pressure-Sensitive Adhesive Sheet (Second Embodiment)

Next, one example of a method for producing a double-face pressure-sensitive adhesive sheet 120 according to the second embodiment will be described.

First, a release sheet 1 and a release sheet 1′ are prepared in the same manner as the method for producing the above release sheet 1 of the single-sided pressure-sensitive adhesive sheet 100.

Next, a pressure-sensitive adhesive composition is supplied onto a release agent layer 11 of the release sheet 1 to obtain a coating film. Then, by heating and drying the coating film, a double-face pressure-sensitive adhesive sheet body 2″ composed of a single pressure-sensitive adhesive layer is formed on the release agent layer 11.

Thereafter, by sticking the release sheet 1′ on the double-face pressure-sensitive adhesive sheet body 2″ formed on the release agent layer 11, the double-faced pressure-sensitive adhesive sheet 120 can be obtained.

Although the release agent composition, the release sheet, the single-sided pressure-sensitive adhesive sheet (pressure-sensitive adhesive article) and the double-sided (faced) pressure-sensitive adhesive sheet (pressure-sensitive adhesive article) according to the present invention have been described with reference to the preferred embodiments thereof, the present invention is not limited thereto.

Further, although the case that the release sheet is composed of the release agent layer and the base material has been described in the above embodiment, a release agent layer may also have the function of the base material like a resin film. Namely, the release sheet may be composed of a single layer.

Further, the methods for producing the release sheet, the single-sided pressure-sensitive adhesive sheet and the double-sided (faced) pressure-sensitive adhesive sheet according to the present invention are not limited to the above-described producing methods.

Furthermore, the adherends to which the pressure-sensitive adhesive article according to the present invention adheres are not limited to the electrical components such as relays, various switches, connectors, motors, hard disk drives as described above. For example, the adherend may be an industrial product such as display or the like, a household product such as window glass, stationery, or the like.

### EXAMPLES

Next, specific examples according to the present invention will be described.

1. Production of Release Sheet

### Example 1

First, 100 mass parts (35 mass parts as solid content) of a 35% toluene solution of a polyester resin (manufactured by Toyobo Co., Ltd. under the trade name of “Byron 220”, number average molecular weight (Mn): 3000, hydroxyl value: 50 mgKOH/g, glass transition temperature 53° C.), 50 mass parts (15 mass parts as solid content) of a 30% toluene solution of an acrylic polymer (mass ratio: DTDA/HEA=99/1), 5 mass parts (4 mass parts as solid content) of a melamine resin (manufactured by Kotobukikakou Co., Ltd. under the trade name of “TF200”, solid content of 80 mass %) as a crosslinking agent, and a mixed solvent (toluene:methyl ethyl ketone=70:30 (mass ratio)) were mixed and stirred to obtain a liquid mixture.

2.0 mass parts (1.0 mass parts as solid content) of a methanol solution of p-toluenesulfonic acid (containing 50 mass % of p-toluenesulfonic acid) as a catalyst was added to the obtained liquid mixture, and then stirred to obtain a release agent composition (solution) having a solid content of 2.5 mass %.

The obtained release agent composition was applied on a polyethylene terephthalate film (manufactured by Mitsubishi Plastics, under the trade name of “T-100”, thickness 50 μm) as a base material using a mayer bar, so that a thickness of 150 nm was achieved after drying. Thereby, a coating film was obtained.

Thereafter, the coating film was dried at 150° C. for 1 minute and cured to form a release agent layer on the base material. Thereafter, it was seasoned for one week under an atmosphere of 23° C. and 50% RH to obtain a release sheet composed of the base material and the release agent layer.

In the above description, DTDA is 2-decyltetradecanyl acrylate, and HEA is 2-hydroxyethyl acrylate.

### Example 2

A release sheet was produced in the same manner as in Example 1 except that an acrylic polymer (mass ratio: DTDMA/HEA=99/1) was used in place of the acrylic polymer (mass ratio: DTDA/HEA=99/1).

In the above description, DTDMA is 2-decyltetradecanyl methacrylate.

### Example 3

A release sheet was produced in the same manner as in Example 1 except that an acrylic polymer (mass ratio: 2HDA/HEA=99/1) was used in place of the acrylic polymer (mass ratio: DTDA/HEA=99/1).

In the above description, 2HDA is 2-hexyldecyl acrylate.

### Example 4

A release sheet was produced in the same manner as in Example 1 except that an acrylic polymer (mass ratio: DTDA/HEA=95/5) was used in place of the acrylic polymer (mass ratio: DTDA/HEA=99/1).

### Comparative Example 1

A release sheet was produced in the same manner as in Example 1 except that an acrylic polymer (mass ratio: BA/HEA=99/1) was used in place of the acrylic polymer (mass ratio: DTDA/HEA=99/1).

In the above description, BA is butyl acrylate.

### Comparative Example 2

A release sheet was produced in the same manner as in Example 1 except that an acrylic polymer (mass ratio: LA/HEA=99/1) was used in place of the acrylic polymer (mass ratio: DTDA/HEA=99/1).

In the above description, LA is lauryl acrylate.

### Comparative Example 3

A release sheet was produced in the same manner as in Example 1 except that an acrylic polymer (mass ratio: MyA/HEA=99/1) was used in place of the acrylic polymer (mass ratio: DTDA/HEA=99/1).

In the above description, MyA is myristyl acrylate.

### Comparative Example 4

A release sheet was produced in the same manner as in Example 1 except that an acrylic polymer (mass ratio: StA/HEA=99/1) was used in place of the acrylic polymer (mass ratio: DTDA/HEA=99/1).

In the above description, StA is stearyl acrylate.

2. Production of Pressure-Sensitive Adhesive Sheet

An adhesive (manufactured by Toyo Chem, under the trade name of “BPS-5127”) was applied on the release sheet obtained in each of Examples and Comparative Examples using an applicator to obtain a coating film, so that a film thickness of about 25 μm was achieved after drying. The obtained coating film was heated at 100° C. for 2 minutes and dried to form a pressure-sensitive adhesive layer.

A PET film (manufactured by Mitsubishi Chemical, trade name: PET50-T100) having a thickness of 50 μm was stuck on the formed pressure-sensitive adhesive layer to obtain a pressure-sensitive adhesive sheet (single-sided pressure-sensitive adhesive sheet).

3. Evaluation

[Measurement of Release Agent Component Occupied Ratio]

A polyester film (manufactured by Mitsubishi Chemical Polyester Film, trade name: PET50-T100) was contacted with the release agent layer of the release sheet obtained in each of Examples and Comparative Examples and was left for 24 hours under a pressure of 10 kg/cm² at room temperature. Thereafter, the release agent layer was removed from the polyester film and a surface element analysis by XPS was conducted for a surface of the polyester film contacted with the release agent layer. Thereby, an element ratio was obtained and then by using the element ratio, a release agent component occupied ratio A on the surface of the polyester film contacted with the release agent layer was calculated.

In this regard, when an amount of carbon on the surface of the polyester film contacting with the release agent layer obtained in the surface element analysis by XPS is defined as Cₜₒₜₐₗ [atomic %], an amount of carbon on the surface of the original polyester film is defined as C_{b} (atomic %), an amount of carbon on the surface of the release agent layer is defined as Cₐ [atomic %] and a ratio of a release agent component on the surface of the polyester film contacting with the release agent layer (release agent component occupied ratio) is defined as A %, Cₜₒₜₐₗ={A×Cₐ+(100−A)×C_{b}}/100 is established. According to the formula, the release agent component occupied ratio A, which is the measure of the release agent transfer amount, was calculated.

In the release sheet of Comparative Example 1, a blocking between the polyester film and the release agent layer occurred, and it was impossible to measure the release agent component occupied ratio A.

[Measurement by XPS]

PHI Quantera SXM (manufactured by ULVAC-PHI, Inc.) was used for measurement by XPS of the surface of the release agent layer of the release sheet obtained in each of Examples and Comparative Examples. The Measurement by XPS was carried out at a photoelectron takeoff angle of 45° using monochromatic AlKα as an X-ray source. Thereby, an element ratio of carbon, oxygen and silicon existing on the surface of each release agent layer was calculated.

[Measurement of Surface Free Energy]

Contact angles of the surface of the release agent layer of the release sheet obtained in each of Examples and Comparative Examples with respect to three liquids of water, diiodomethane and dibromonaphthalene were measured using a contact angle meter (manufactured by Kyowa Interface Science Co., Ltd., DM-701) under an atmosphere of 23° C. and 50% RH, and a surface free energy was calculated by a Kitasaki Hata method.

[Release Force Test]

The pressure-sensitive adhesive sheet with the release sheet of each of Examples and Comparative Examples was seasoned in an atmosphere of 23° C. and 50% RH for 1 week.

Thereafter, the pressure-sensitive adhesive sheet was cut into a piece having a width of 20 mm and a length of 200 mm to obtain a test piece. The test piece was fixed on a test stand of the tensile tester (manufactured by Orientec Corporation: Tensilon) with a double-sided tape, and then a release force was measured when the release sheet was pulled from the pressure-sensitive adhesive layer in a peeling angle of 180° at a peeling speed of 0.3 m/min using the tensile tester (manufactured by Orientec Corporation: Tensilon) in accordance with JIS-Z 0237.

These results were shown in Table 1 an Table 2 with the composition and the like of the acrylic polymer of each release sheet in each of the Examples and the Comparative Examples described above.

TABLE 1

| | Release Sheet | | | | Release Agent |
|---|---|---|---|---|---|
| | | Mass Average | Carbon number of | | Component |
| | | Molecular | Alkyl Group of | Branched | Occupied Ratio |
| | Acrylic Polymer | Weight | Side Chain | Structure | [%] |
| Example 1 | DTDA/HEA = 99/1 | 168,900 | 24 | Having | 19.5 |
| Example 2 | DTDMA/HEA = 99/1 | 203,900 | 24 | Having | 25.2 |
| Comparative | BA/HEA = 99/1 | 181,000 | 4 | Not having | Unmeasurable |
| Example 1 | | | | | |
| Comparative | LA/HEA = 99/1 | 148,300 | 12 | Not having | 78.7 |
| Example 2 | | | | | |
| Comparative | MyA/HEA = 99/1 | 480,000 | 14 | Not having | 35.6 |
| Example 3 | | | | | |
| Comparative | StA/HEA = 99/1 | 105,000 | 18 | Not having | 37.2 |
| Example 4 | | | | | |

| | | | | Surface | |
|---|---|---|---|---|---|
| | | | | Free | |
| | Surface Element Ratio | | | Energy | Release Force |
| | C [atomic %] | O [atomic %] | Si [atomic %] | [mJ/m²] | [mN/20 mm] |
| Example 1 | 94.0 | 6.0 | 0.0 | 32.2 | 100 |
| Example 2 | 93.5 | 6.5 | 0.0 | 28.7 | 190 |
| Comparative | 77.8 | 22.2 | 0.0 | 40.1 | Unpeelable |
| Example 1 | | | | | |
| Comparative | 88.1 | 11.9 | 0.0 | 37.7 | 160 |
| Example 2 | | | | | |
| Comparative | 89.5 | 10.5 | 0.0 | 36.2 | 170 |
| Example 3 | | | | | |
| Comparative | 91.3 | 8.7 | 0.0 | 34.3 | 290 |
| Example 4 | | | | | |

TABLE 2

| | Release Sheet | | | | Release Agent |
|---|---|---|---|---|---|
| | | Mass Average | Carbon number of | | Component |
| | | Molecular | Alkyl Group of | Branched | Occupied Ratio |
| | Acrylic Polymer | Weight | Side Chain | Structure | [%] |
| Example 3 | 2HDA/HEA = 99/1 | 163,300 | 16 | Having | 28.5 |
| Example 4 | DTDA/HEA = 95/5 | 117,300 | 24 | Having | 30.6 |

| | | | | Surface | |
|---|---|---|---|---|---|
| | | | | Free | |
| | Surface Element Ratio | | | Energy | Release Force |
| | C [atomic %] | O [atomic %] | Si [atomic %] | [mJ/m²] | [mN/20 mm] |
| Example 3 | 90.1 | 9.9 | 0.0 | 29.7 | 120 |
| Example 4 | 93.2 | 6.6 | 0.0 | 30.2 | 100 |

As can be seen from Table 1 and Table 2, in the release sheet using the release agent composition according to the present invention, it became possible to suppress the release agent composition from transferring to a base material such as polyester film or the like. Further, in the release sheet using the release agent composition according to the present invention, it was possible to easily peel off the pressure-sensitive adhesive sheet. On the other hand, in each Comparative Example, satisfactory result could not be obtained.

Further, since the release sheet according to the present invention did not contain any silicone compound, it was hard to give the adverse effects to an electric component such as relay or the like.

### INDUSTRIAL APPLICABILITY

According to the present invention, it is possible to provide the release agent composition which can sufficiently suppress the adverse effects on electric components such as relays, various switches, connectors, motors, hard disk drives and to provide the release sheet formed from such a release agent composition, the single-sided pressure-sensitive adhesive sheet having such a release sheet and the double-sided (faced) pressure-sensitive adhesive sheet having such release sheets. Therefore, the present invention has industrial applicability.

### EXPLANATION OF REFERENCE NUMERAL

100: single-sided pressure-sensitive adhesive sheet
110, 120: double-sided (faced) pressure-sensitive adhesive sheet
1, 1′: release sheet
11, 11′: release agent layer
12, 12′: base material
2: single-sided pressure-sensitive adhesive sheet body
2′, 2″: double-sided (faced) pressure-sensitive adhesive sheet body
21, 21A, 21B: pressure-sensitive adhesive layer
22: pressure-sensitive adhesive sheet base
22′ core material

1. A release agent composition comprising:
a polyester resin (A) and an acrylic polymer (B),
wherein the acrylic polymer (B) includes a structural unit represented by the following structural formula (1) and
wherein a ratio of a blending amount of the polyester resin (A) to a blending amount of the acrylic polymer (B) is in the range of (A):(B)=50:50 to 95:5 in a mass ratio, 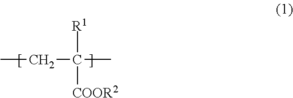
where R¹ is H or CH₃ and R² is an alkyl group having a branched structure and having carbon atoms of 10 or more and 30 or less.

2. The release agent composition as claimed in claim 1 further comprising a crosslinking agent (C).

3. The release agent composition as claimed in claim 1, wherein the acrylic polymer (B) includes 80 mass % or more of the structural unit represented by the structural formula (1).

4. The release agent composition as claimed in claim 1, wherein the acrylic polymer (B) has at least one functional group selected from the group consisting of a hydroxyl group, an amino group and a carboxyl group.

5. The release agent composition as claimed in claim 1, wherein the polyester resin (A) has a number average molecular weight of 500 or more and 10,000 or less.

6. The release agent composition as claimed in claim 1, wherein the acrylic polymer (B) has a mass average molecular weight of 50,000 or more and 500,000 or less.

7. The release agent composition as claimed in claim 1, wherein an amount of a silicone compound contained in the release agent composition is measured by X-ray photoelectron spectroscopy (XPS), and the amount is 0.5 atomic % or less.

8. A release sheet comprising:
a base material; and
a release agent layer composed of a cured product of a release agent composition and provided on at least a side of one surface of the base material;
wherein the release agent composition comprises:
a polyester resin (A) and an acrylic polymer (B),
wherein the acrylic polymer (B) includes a structural unit represented by the following structural formula (1) and
wherein a ratio of a blending amount of the polyester resin (A) to a blending amount of the acrylic polymer (B) is in the range of (A):(B)=50 50:50 to 95:5 in a mass ratio, 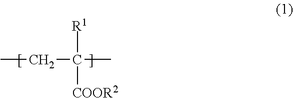
where R¹ is H or CH₃ and R² is an alkyl group having a branched structure and having carbon atoms of 10 or more and 30 or less.

9. The release sheet as claimed in claim 8, wherein a surface free energy of the release agent layer is measured by a contact angle method, and the surface free energy is 40 mJ/m² or less.

10. The release sheet as claimed in claim 8, wherein a ratio of C element on a surface of the release agent layer in a surface element analysis is measured by XPS, and the ratio of C element is 85 atomic % or more.

11. The release sheet as claimed in claim 8, wherein a ratio of Si element on a surface of the release agent layer in a surface element analysis is measured by XPS, and the ratio of Si element is less than 0.5 atomic %.

12. The release sheet as claimed in claim 8, wherein after a polyester film is contacted with the release agent layer of the release sheet and is left for 24 hours under a pressure of 10 kg/cm² at room temperature, a release agent component occupied ratio in the polyester film is 40% or less, wherein the release agent component occupied ratio is obtained by conducting a surface element analysis by XPS for a surface of the polyester film contacting with the release agent layer.

13. The release sheet as claimed in claim 8, wherein the release agent layer has an average thickness of 0.01 μm or more and 1.0 μm or less.

14. A pressure-sensitive adhesive sheet comprising:
a pressure-sensitive adhesive sheet base or a core material;
a pressure-sensitive adhesive layer laminated on a surface of the pressure-sensitive adhesive sheet base or a surface of the core material; and
a release sheet laminated on an adhesive surface of the pressure-sensitive adhesive layer,
wherein the release sheet is formed from a release agent composition;
wherein the release agent composition comprises:
a polyester resin (A) and an acrylic polymer (B),
wherein the acrylic polymer (B) includes a structural unit represented by the following structural formula (1) and
wherein a ratio of a blending amount of the polyester resin (A) to a blending amount of the acrylic polymer (B) is in the range of (A):(B)=50 50:50 to 95:5 in a mass ratio, 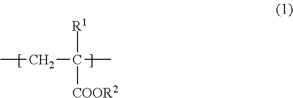
where R¹ is H or CH₃ and R² is an alkyl group having a branched structure and having carbon atoms of 10 or more and 30 or less.

15. The pressure-sensitive adhesive sheet as claimed in claim 14, wherein the pressure sensitive adhesive sheet further comprises a single-sided pressure sensitive adhesive sheet, and wherein the pressure-sensitive adhesive layer is used for indication of a content of an adherend to which the pressure-sensitive adhesive layer adheres.

16. (canceled)

17. (canceled)

18. The pressure-sensitive adhesive sheet as claimed in claim 14, further comprising:
an additional pressure-sensitive adhesive layer laminated on a different surface of the core material; and
an additional release sheet laminated on an adhesive surface of the additional pressure-sensitive adhesive layer.

19. The pressure-sensitive adhesive sheet as claimed in claim 18, wherein the additional release sheet is formed from the release agent composition.

20. The pressure-sensitive adhesive sheet as claimed in claim 14, further comprising:
an additional release sheet laminated on a different adhesive surface of the pressure-sensitive adhesive layer.

21. The pressure-sensitive adhesive sheet as claimed in claim 20, wherein the additional release sheet is formed from the release sheet composition.
